(19) United States
(12) Patent Application Publication
(10) Pub. No.: US 2010/0079654 A1
(43) Pub. Date: Apr. 1, 2010

(54) Picture frame with internal camera source

(75) Inventor: Andrew J. Egemo, Somerset, WI (US)

Correspondence Address: Shumaker & Sieffert. P.A., 1625 Radio Drive, Suite 300, Woodbury, MN, 55125, US

(73) Assignee: Imation Corp.

(21) Appl. No.: 12/286,170

(22) Filed: Sep. 29, 2008

(51) Int. Cl. H04N 5/222; H04N 5/225

(52) U.S. Cl. 348/333.01; 348/373; 348/E05.022; 348/E05.024

(57) ABSTRACT

An apparatus for taking and displaying photographs includes a back surface, an image display surface, and a camera assembly in electrical communication with the image display surface. The camera assembly is disposed along opposed edges of the back surface and the image display surface and includes a lens that is pointable in a direction facing away from the back surface and movable to be pointed in a direction facing away from the image display surface.

### FIELD

The field of this disclosure relates to a digital picture frame including an internally integrated camera source configured to capture images from at least a 180 degree field of view for display on a screen of the digital picture frame.

### BACKGROUND

Digital picture frames are popular electronic devices that display digital pictures taken with a digital camera. Digital cameras electronically store digital information of captured images in some form of memory. In some cases the memory is a portable memory, such as a card or memory stick, that is removed from the camera and inserted into the digital picture frame to enable one or more people to view the captured/saved images. In other cases, the camera is attached to the digital picture frame by a cable and the captured/saved images are downloaded to the picture frame for viewing. Consumers would welcome improvements made to these conventional digital picture frames.

For this reason, there is a need for the present invention.

### SUMMARY

One aspect provides an apparatus for taking and displaying photographs. The apparatus includes a back surface, an image display surface, and a camera assembly in electrical communication with the image display surface. The camera assembly is disposed along opposed edges of the back surface and the image display surface and includes a lens that is pointable in a direction facing away from the back surface and movable to be pointed in a direction facing away from the image display surface.

One aspect provides a camera system including a housing and a camera assembly integrated within the housing. The housing includes a base, a back surface extending between the base and a leading edge, an image display surface extending between the base and a leading edge, and a cap attached to the leading edges of the back surface and the image display surface. The camera assembly is integrated within the cap and is in electrical communication with the image display surface. The camera assembly has a lens configured to photograph subjects facing the back surface and movable to photograph subjects facing the image display surface.

One aspect provides a method of providing a picture frame configured to photograph a subject. The method includes providing the picture frame with an image display screen and a camera assembly having a movable lens. The method includes configuring the movable lens to capture images of subjects facing the image display screen, and configuring the movable lens to rotate and capture images of subjects behind the image display screen.

### BRIEF DESCRIPTION OF THE DRAWINGS

The accompanying drawings are included to provide a further understanding of embodiments and are incorporated in and constitute a part of this specification. The drawings illustrate embodiments and, together with the description, serve to explain principles of embodiments. Other embodiments and many of the intended advantages of embodiments will be readily appreciated as they become better understood by reference to the following detailed description. The elements of the drawings are not necessarily to scale relative to each other. Like reference numerals designate corresponding similar parts.

FIG. 1 is a block diagram of a camera system apparatus according to one embodiment;

FIG. 2 is a front perspective view of a camera system including a picture frame having an internally integrated camera assembly according to one embodiment;

FIG. 3 is a back perspective view of the picture frame illustrated in FIG. 2;

FIG. 4 is a back perspective view of the picture frame illustrated in FIG. 2 oriented in a portrait mode;

FIG. 5A is a front perspective view of the picture frame illustrated in FIG. 2 with the internally integrated camera assembly configured to capture images of a subject in front of its display screen; and

FIG. 5B is a front perspective view of the picture frame illustrated in FIG. 5A with the internally integrated camera assembly rotated to capture images of a subject behind its display screen.

### DETAILED DESCRIPTION

In the following Detailed Description, reference is made to the accompanying drawings, which form a part hereof, and in which is shown by way of illustration specific embodiments in which the invention may be practiced. In this regard, directional terminology, such as “top,” “bottom,” “front,” “back,” “leading,” “trailing,” etc., is used with reference to the orientation of the Figure(s) being described. Because components of embodiments can be positioned in a number of different orientations, the directional terminology is used for purposes of illustration and is in no way limiting. It is to be understood that other embodiments may be utilized and structural or logical changes may be made without departing from the scope of the present invention. The following detailed description, therefore, is not to be taken in a limiting sense, and the scope of the present invention is defined by the appended claims.

It is to be understood that the features of the various exemplary embodiments described herein may be combined with each other, unless specifically noted otherwise.

Embodiments described herein provide a digital picture frame including an internally integrated camera source configured to capture images from at least a 180 degree field of view for display on a screen of the digital picture frame. In one embodiment, the screen is provided as an image display surface and the camera assembly is disposed along one of the edges of the picture frame. A lens of the camera assembly is independently moveable apart from the frame through at least 180 degrees to be pointable toward a back side of the picture frame and rotated to be pointed toward a front side of the picture frame. In other words, the lens of the camera assembly is moveable to selectively capture images in front of and/or behind the picture frame.

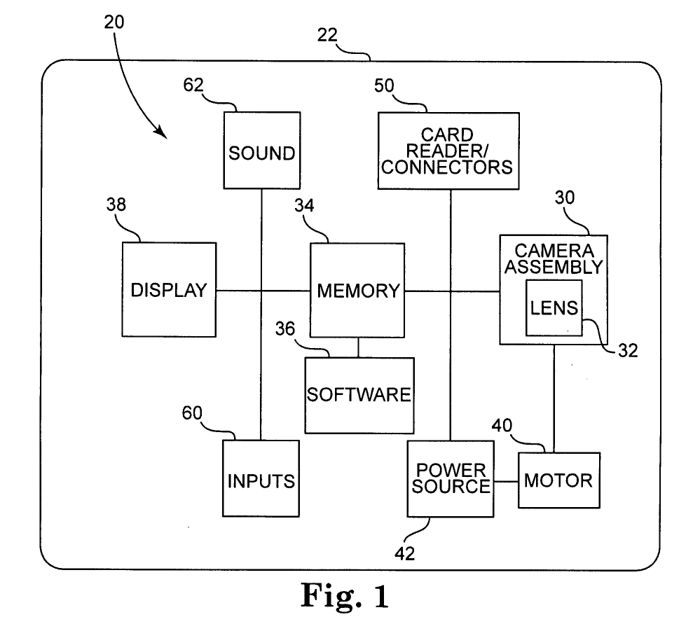

FIG. 1 is a block diagram 20 of an apparatus 22 according to one embodiment. In one embodiment, the apparatus 22 is a picture frame including an internally integrated camera assembly 30 communicating with a lens 32 that has memory 34 configured to store pictures and software 36 configured to edit, organize, and retrieve pictures that are displayed on a display 38. The lines of block diagram 20 represent electrical communication pathways or other communication pathways between the components of apparatus 22.

The lens 32 of the camera assembly 30 is moveable and communicates with a motor 40 connected to a power source 42. In one embodiment, apparatus 22 includes one or more card reader/connector 50 configured to communicate with memory 34 and display 38. For example, images stored on or saved to the card readers/connectors 50 are electronically displayed on display 38. Alternatively, captured images are edited by software 36 and electronically stored in memory 34, on connectors 50, or displayed on display 38. The card reader/connector 50 is portable and insertable/removable from apparatus 22.

In one embodiment, apparatus 22 includes various inputs 60 to provide apparatus 22 with Wi-Fi capability, RSS feed capability, or PictBridge capability. In one embodiment, one of the inputs 60 provides a video based input and apparatus 22 includes electronics for generating sound 62 employed with the videos.

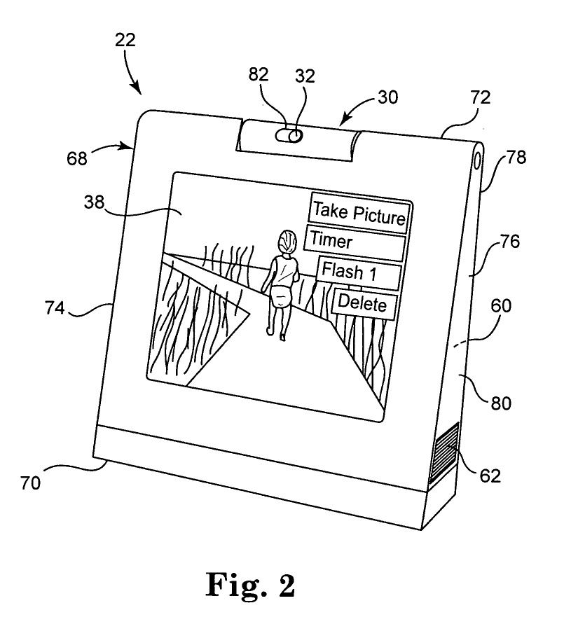

FIG. 2 is a front perspective view of apparatus 22. Apparatus 22 (or camera system 22) includes housing 68 defined by a base 70 opposite a cap 72, a first side 74 generally opposite a second side 76, and a back surface 78 generally opposite from image display surface 38. In one embodiment, back surface 78 and image display surface 38 are non-parallel. In one embodiment, side 76 includes an access door 80 that opens to expose inputs 60 and closes to protectively cover inputs 60. In one orientation, camera system 22 is configured to rest on base 70 such that camera assembly 30 atop housing 68. In one embodiment, camera system 22 is configured to rest on side 74 in a portrait mode with camera assembly 30 alongside housing 68. Camera assembly 30 and lens 32 combine to photographically capture images for viewing on display 38, and in one embodiment image display surface 38 provides the only view finder that is employed by the camera assembly 30.

In one embodiment, lens 32 is exposed within a window 82, and at least lens 32 of camera assembly 30 is moveable through at least 180 degrees from a direction oriented toward image display surface 38 (e.g., the front) toward a direction facing the back surface 78 (e.g., the back). In one embodiment, the image display surface 38 is provided as a graphical user interface through which a user can interact with camera system 22.

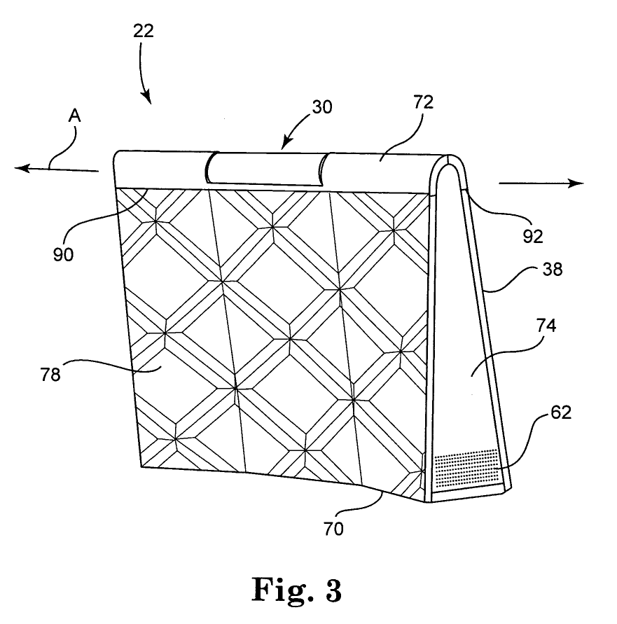

FIG. 3 is a back perspective view of camera system 22. Back surface 78 extends from base 70 to a leading edge 90 of back surface 78, and image display surface 38 extends from base 70 to a leading edge 92 of image display surface 38. The camera assembly 30 is generally disposed between the leading edges 90, 92 of the back surface 78 and the image display surface 38. For example, in one embodiment cap 72 is coupled between the leading edges 90, 92 of the respective back surface 78 and the image display surface 38 and the camera assembly 30 is integrated with cap 72. At least the lens 32 (FIG. 2) is rotatable between image display surface 38 and back surface 78 to capture a 180 degree field of view relative to housing 68.

For example, in one embodiment, camera assembly 30 includes a substantially cylindrical camera assembly that is axially aligned in cap 72 on a major axis A. In one embodiment, cap 72 is provided as an arched cap that is semicircular in lateral cross-section and is configured to receive the cylindrical camera assembly 30. At least the lens 32 of camera assembly 30 moves around the major axis A to photograph subjects facing the back surface 78 and rotate to photograph subjects facing the image display surface 38. Lens 32 is movable through at least a 180 degree arc and is configured to point in a direction away from back surface 78 and image display surface 38 (for example upwards).

With reference to FIGS. 1-3, in one embodiment camera assembly 30 is provided as an integrated 3.1 mega-pixel camera that is rotatable and includes a light emitting diode (LED) indicator of camera status. In one embodiment, camera assembly 30 includes a built-in flash configured to capture images in low light conditions.

The electrical specifications of camera system 22 provide for an internal clock and calendar having on/off programmability, Wi-Fi capability, and RSS feed. RSS is a web format employed to publish frequently updated works such as video. In general, RSS feeds are read using software provided in an RSS reader or feed reader or an aggregator. The RSS feed is available in formats including “really simple syndication,” “RDF site summary,” or “rich cite summary.” Memory 34 is provided that is sufficient to capture and edit thousands of digital pictures. In one embodiment, memory 34 includes an electronically erasable programmable memory having a size between approximately 1-4 gigabytes.

In one embodiment, the software 36 is configured to provide basic photo editing such as red eye removal, cropping, photo effects (sepia, black and white, etc.).

In one embodiment, image display surface 38 is provided as a graphical user interface (GUI) having a resolution between approximately 800×600. One embodiment of the GUI includes spin GUI wire frames and architecture. Other formats for display 38 are also acceptable. In one embodiment, housing 68 is provided as an 8 inch panel and display 38 is configured to have an aspect ratio of approximately 4.3.

In one embodiment, motor 40 is an electric DC motor sized to rotate a camera assembly 30 having a mass of less than about 30 grams.

In one embodiment, power source 42 is provided as a rechargeable lithium ion battery compatible with a charging dock (not shown). The charging dock is configured to recharge camera system 22 by plugging into an AC power source.

The card reader/connectors 50 include various memory card readers configured to read secure digital (SD) cards, memory stick (MS) cards, compact flash (CF) cards, extreme digital (XD) picture cards, or other such suitable memory cards.

In one embodiment, sound 62 is provided as one or more speakers built in housing 68 and communicating through perforations formed in sides 74, 76.

The camera system 22 is provided within a photo frame formed by housing 68 and display 38 and includes an integrated high resolution camera assembly 30 that allows users to take pictures and show them simultaneously on the image display surface 38. The camera system 22 does away with users transporting their images from a memory card in a camera to a display frame for viewing. The camera system 22 is portable and includes a timer function communicating with memory 34 that allows the user to photograph themselves (and/or others) at a distance beyond arm length.

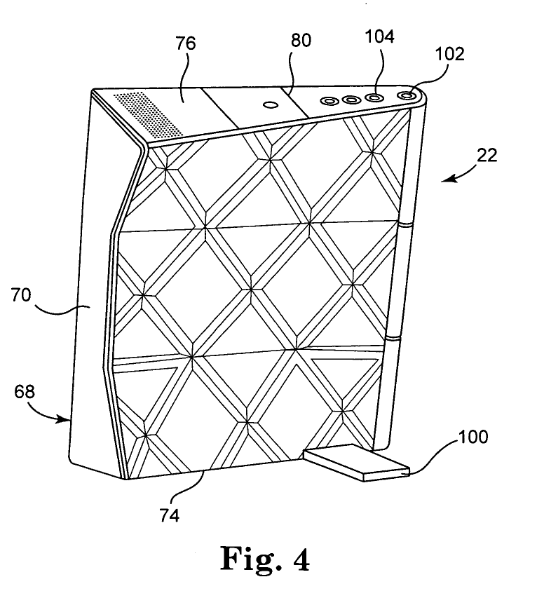

FIG. 4 is a back perspective view of camera system 22 balanced on side 74 by a slide foot 100 according to one embodiment. Slide foot 100 is configured to rotate or slide from housing 68 to support camera system 22 in portrait mode. Side 76 includes the access door 80 covering the inputs 60 (FIGS. 1-2), a scroll wheel 102 for navigating GUI 38, and a power button 104 having an LED backlight.

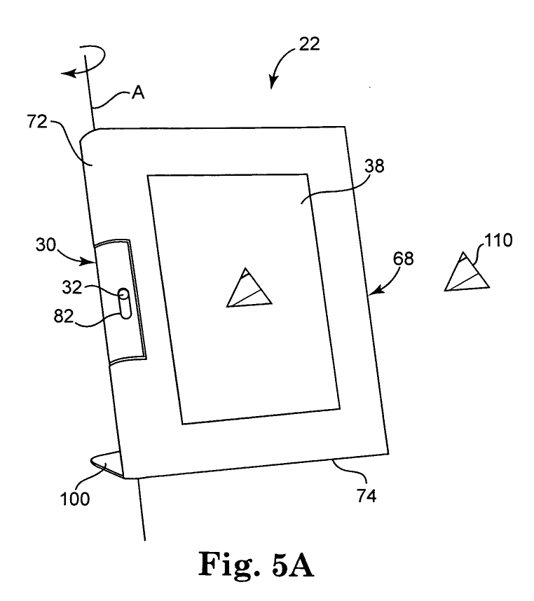

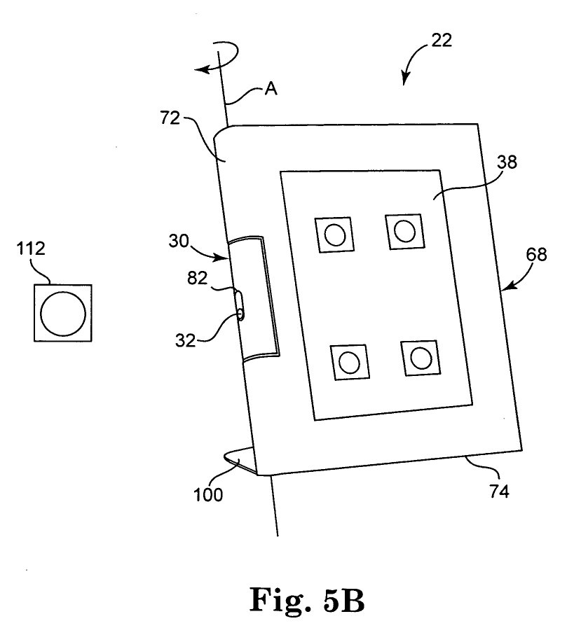

FIG. 5A is a front perspective view of camera system 22 standing on side 74 in portrait mode. In one embodiment, camera system 22 includes an optional orientation sensor (not shown) configured to auto-rotate images on display 38 between the landscape mode and the portrait mode. In one embodiment, camera assembly 30 rotates on axis A to direct lens 32 toward an object 110 that is placed in front of image display surface 38. Lens 32 within window 82 captures an image of the object 110 and displays image on display surface 38. With additional reference to FIG. 1, software 36 and memory 34 are available for editing the image prior to or subsequent to displaying the image on display surface 38.

FIG. 5B is another front perspective view of camera system 22 supported on side 74 in portrait mode. In one embodiment, camera assembly 30 is rotated by motor 40 (FIG. 1) to direct lens 32 toward an object 112 that is behind image display surface 38. Lens 32 moves independent of display 38 and independent of housing 68. Thus, without moving housing 68, lens 32 has moved to capture (or photograph) the object 112 that is behind display surface 38. Display 38 functions as a view finder in one embodiment as well as a display surface of the captured image of the object 112.

In one embodiment, image display surface 38 is configured to display an image of object 112 in a split screen format within four quadrants. Display surface 38 is also configured to display image of object 112 in a split screen side by side (or half) format, or in the full format illustrated in FIG. 5A. In one embodiment, the image display screen 38 is configured to display sequences of the images of the object 110 facing the image display screen and the images of objects 112 behind the image display screen.

In one embodiment, images of the objects 110, 112 are captured by lens by pushing a shutter release button provided on one of the sides of camera system 22. In another embodiment, images of objects 110, 112 are captured by camera system 22 by remotely controlling the digital image capture of camera assembly 30.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of a picture frame having an internal camera source as discussed herein.

What is claimed is:

1. An apparatus comprising:
a back surface;
an image display surface; and
a camera assembly in electrical communication with the image display surface, the camera assembly disposed along opposed edges of the back surface and the image display surface, the camera assembly comprising a lens pointable in a direction facing away from the back surface and movable to be pointed in a direction facing away from the image display surface.

2. The apparatus of claim 1, wherein the back surface and the image display surface are non-parallel.

3. The apparatus of claim 1, wherein the back surface extends from a base to a leading edge of the back surface and the image display surface extends from the base to a leading edge of the image display surface, the camera assembly disposed between the leading edges of the back surface and the image display surface.

4. The apparatus of claim 3, further comprising:
a cap coupled between the leading edges of the back surface and the image display surface, wherein the camera assembly is integrated with the cap and the lens is disposed in a window formed in the cap.

5. The apparatus of claim 4, wherein the camera assembly comprises a cylindrical camera assembly axially aligned in the cap.

6. The apparatus of claim 5, wherein the lens comprises a rotatable lens configured to rotate on a major axis of the camera assembly.

7. The apparatus of claim 6, wherein the rotatable lens is configured to rotate at least approximately 180 degrees on the major axis of the camera assembly to photograph subjects facing the back surface and rotate to photograph subjects facing the image display surface.

8. The apparatus of claim 6, wherein the rotatable lens is configured to rotate to point in a direction away from both the back surface and the image display surface.

9. The apparatus of claim 1, wherein the image display surface comprises the only view finder employed by the camera assembly.

10. A camera system comprising:
a housing comprising a base, a back surface extending between the base and a leading edge, an image display surface extending between the base and a leading edge, and a cap attached to the leading edges of the back surface and the image display surface; and
a camera assembly integrated within the cap and in electrical communication with the image display surface, the camera assembly comprising a lens configured to photograph subjects facing the back surface and movable to photograph subjects facing the image display surface.

11. The camera system of claim 10, wherein the lens comprises a rotatable camera lens.

12. The camera system of claim 11, wherein the camera assembly comprises a cylindrical camera assembly and the cap comprises an arched cap that is semi-circular in lateral cross-section and configured to receive the cylindrical camera assembly.

13. The camera system of claim 12, wherein the arched cap defines a major axis and the rotatable camera lens is configured to rotate about the major axis.

14. The camera system of claim 13, wherein the rotatable camera lens is configured to rotate at least 180 degrees about the major axis.

15. A method of providing a picture frame configured to photograph a subject, the method comprising:
providing the picture frame with an image display screen and a camera assembly comprising a movable lens;
configuring the movable lens to capture images of subjects facing the image display screen; and
configuring the movable lens to rotate and capture images of subjects behind the image display screen.

16. The method of claim 15, comprising providing the picture frame with a lens integrated into a peripheral edge of the picture frame.

17. The method of claim 15, comprising providing the picture frame with an internal source for capturing and displaying digital images on the image display screen.

18. The method of claim 15, comprising providing the picture frame with an image display screen comprising the only view finder employed by the camera assembly.

19. The method of claim 15, comprising configuring the image display screen to display sequences of the images of subjects facing the image display screen and the images of subjects behind the image display screen.

20. The method of claim 15, comprising rotating the movable lens from a direction pointing toward the subjects facing the image display screen to a direction pointing toward the subjects behind the image display screen.
